(19) United States
(12) Patent Application Publication
(10) Pub. No.: US 2005/0265155 A1
(43) Pub. Date: Dec. 1, 2005

(54) Optical disc apparatus

(76) Inventors: Osamu Iwano, Akishima-shi (JP); Toshio Ichikawa, Fussa-shi (JP); Manabu Nomoto, Hachioji-shi (JP); Takayuki Saito, Ome-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/944,829

(22) Filed: Sep. 21, 2004

(30) Foreign Application Priority Data
May 31, 2004 (JP) 2004-162118

(51) Int. Cl. G11B 5/09; G11B 7/00

(52) U.S. Cl. 369/47.1; 369/44.14; 369/44.11

(57) ABSTRACT

An optical disc apparatus has a disc motor which rotates an optical disc, a pickup which has a laser element driven by a drive current and irradiates the optical disc with a laser beam, a plurality of signal lines which transfers control information of the drive current to the pickup, and a drive control circuit which serially transfers the control signal to the pickup using at least one of the plurality of signal lines.

### CROSS-REFERENCE TO RELATED APPLICATIONS

This application is based upon and claims the benefit of priority from prior Japanese Patent Application No. 2004-162118, filed May 31, 2004, the entire contents of which are incorporated herein by reference.

### BACKGROUND OF THE INVENTION

1. Field of the Invention

The present invention relates to an improvement of an optical disc apparatus such as a disc drive unit and, more particularly, to a reduction of the number of signal lines of a flexible cable that joins a pickup and its drive control circuit.

2. Description of the Related Art

A pickup that irradiates an optical disc with a laser beam incorporates a laser driver which supplies a drive current to a laser unit. A drive current requires more multi-valued levels and pulse width control requires higher precision upon recording with increasing recording density of an optical disc. The arrangement of an optical disc apparatus is roughly classified into a pickup and a main body board on which various circuits such as a controller and the like are mounted. As a prior art, a scheme that mounts a laser driver in a pickup and mounts a control circuit on a main body board is known (for example, see Jpn. Pat. Appln. KOKAI Publication No. 11-219524). Since the pickup is a movable unit which repetitively moves from the inner periphery to the outer periphery or vice versa, it is connected to the main body board via a cable with flexibility, i.e., a flexible cable.

Furthermore, the pickup is required to have more functions to cope with higher recording density, diversity of recording media, higher recording speed, and the like. For example, pickups which comprise a function of selectively using a plurality of semiconductor laser elements in correspondence with recording media, a function of forcibly turning off a drive current, a function of increasing the current gain of a drive current in a high-speed recording mode, and the like have been currently developed.

In the aforementioned prior art, with the development of a multi-functional pickup, signal lines for function control must be assured in a flexible cable. For example, a signal line used to selectively use a plurality of semiconductor laser elements in correspondence with recording media, a signal line used to forcibly turn off a drive current, and a signal line used to increase the current gain of a drive current in a high-speed recording mode are required in the flexible cable. As a result, the number of signal lines in the flexible cable increases, thus posing problems of an increase in mount area, reliability drop, and the like of a connector connected to the flexible cable.

### BRIEF SUMMARY OF THE INVENTION

An optical disc apparatus according to an embodiment of the present invention comprises a disc motor which rotates an optical disc, a pickup which has a laser element driven by a drive current, and irradiates the optical disc with a laser beam, one or more flexible signal lines which transfer control information of the drive current to the pickup, and a drive control circuit which serially transfers the control information to the pickup using at least one of the one or more signal lines.

According to the aforementioned arrangement that uses serial transfer, a multi-functional pickup can be supported while suppressing an increase in the number of signal lines of a flexible cable as much as possible.

### BRIEF DESCRIPTION OF THE SEVERAL VIEWS OF THE DRAWING

FIG. 1 is a block diagram for explaining the arrangement of an optical disc apparatus according to an embodiment (first embodiment) of the present invention;

FIG. 2 is a block diagram showing an example of the arrangement of a signal generation circuit according to the first embodiment;

FIG. 3 is a block diagram showing an example of the arrangement of a laser driver according to the first embodiment;

FIG. 4 is a block diagram showing an example of the arrangement of a function control circuit according to the first embodiment;

FIG. 5 is a timing chart for explaining the operation of a laser control unit according to the first embodiment;

FIG. 6 is a timing chart for further explaining the operation of the laser control unit according to the first embodiment;

FIG. 7 is a pattern diagram showing an example of the arrangement of a semiconductor integrated circuit according to the first embodiment;

FIG. 8 is a pattern diagram showing another example of the arrangement of a semiconductor integrated circuit according to the first embodiment;

FIG. 9 is a block diagram showing an example of the arrangement of a laser driver according to the first modification of the first embodiment;

FIG. 10 is a block diagram showing an example of the arrangement of an optical disc apparatus according to the second modification of the first embodiment;

FIG. 11 is a block diagram showing an example of the arrangement of a laser driver according to the third modification of the first embodiment;

FIG. 12 is a block diagram for explaining the arrangement of an optical disc apparatus according to another embodiment (second embodiment) of the present invention;

FIG. 13 is a block diagram showing an example of a signal generation circuit according to the second embodiment;

FIG. 14 is a block diagram showing an example of the arrangement of a laser driver according to the second embodiment;

FIG. 15 is a block diagram showing the arrangement of a function control circuit according to the second embodiment;

FIG. 16 is a timing chart for explaining the operation of a laser control unit according to the second embodiment;

FIG. 17 is a block diagram for explaining the arrangement of an optical disc apparatus according to still another embodiment (third embodiment) of the present invention;

FIG. 18 is a block diagram showing an example of the arrangement of a laser driver according to the third embodiment;

FIG. 19 is a block diagram showing an example of a signal generation circuit according to the third embodiment;

FIG. 20 is a timing chart for explaining the operation of a laser control unit according to the third embodiment;

FIG. 21 is a block diagram showing an example of the arrangement of a laser driver according to a modification of the third embodiment;

FIG. 22 is a block diagram showing an example of a laser pickup according to still another embodiment (fourth embodiment) of the present invention;

FIG. 23 is a timing chart for explaining the operation of the arrangement shown in FIG. 22;

FIG. 24 is a diagram for explaining an example of the arrangement when a pair of timing signals are differentially transferred and a plurality of masking signals are non-differentially transferred in signal transfer of a flexible cable based on a trimming pulse scheme; and

FIG. 25 is a block diagram showing an example of a laser pickup according to still another embodiment (fifth embodiment) of the present invention.

### DETAILED DESCRIPTION OF THE INVENTION

Various embodiments of the present invention will be described hereinafter with reference to the accompanying drawings.

### First Embodiment

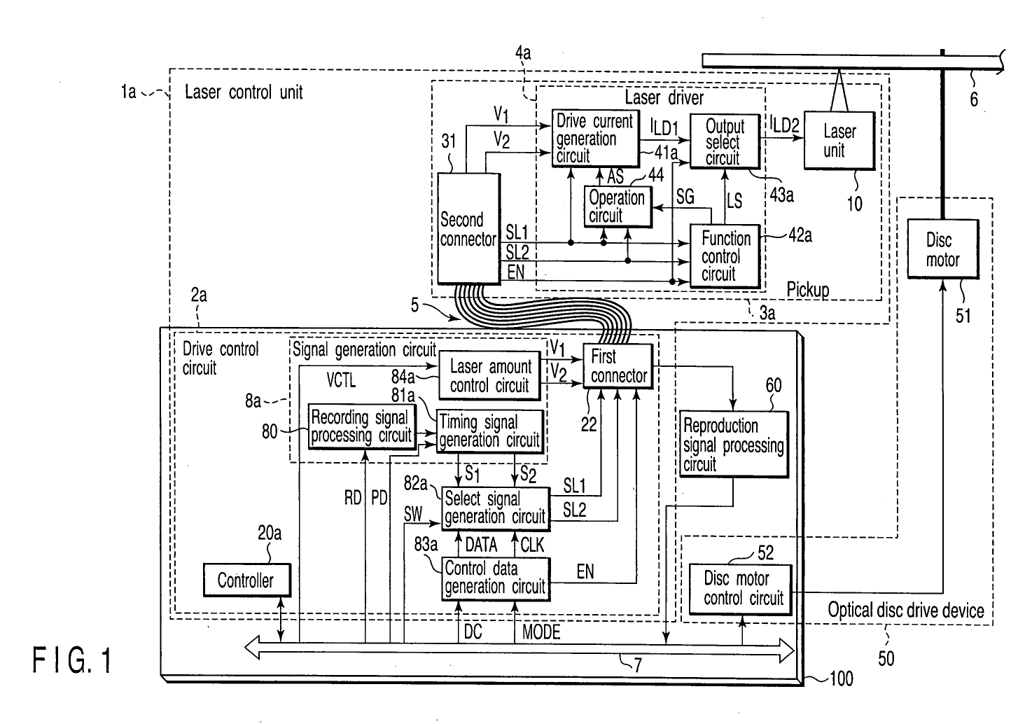

An optical disc apparatus according to the first embodiment of the present invention comprises optical disc 6, system bus 7, laser control unit 1a that controls a laser beam with which optical disc 6 is to be irradiated, optical disc drive unit 50 that drives optical disc 6, and reproduction signal processing circuit 60 that generates a reproduction signal from a signal read out from optical disc 6, as shown in FIG. 1. Laser control unit 1a generates laser drive current ILD2, and comprises pickup 3a that irradiates optical disc 6 with a laser beam, a plurality of signal lines 5 that transfer control information of drive current ILD2 to pickup 3a, and drive control circuit 2a that transfers control data DATA used in function control of pickup 3a to pickup 3a using the plurality of signal lines 5 during only a period in which drive current ILD2 assumes a constant value. The plurality of signal lines 5 are formed in a flexible cable. Drive control circuit 2a supplies a plurality of current setting signals V1, V2, . . . and a plurality of waveform control signals S1, S2, . . . , which are used to generate drive current ILD2 during a period in which drive current ILD2 has a pulse shape, to pickup 3a as control information of drive current ILD2. Note that the “period in which drive current ILD2 has a pulse shape” means, for example, a recording mode of the optical disc apparatus. The “period in which drive current ILD2 assumes a constant value” means, for example, a standby mode, reproduction mode, and the like of the optical disc apparatus. Also, “function control” means control for functions other than generation of drive current ILD2 such as a function of selectively using semiconductor laser elements used to emit a laser beam in correspondence with the type of optical disc 6, a function of selecting an arithmetic process to be executed in pickup 3a, and the like.

Optical disc drive unit 50 comprises disc motor 51 for driving optical disc 6, and disc motor control circuit 52 for controlling disc motor 51. Drive control circuit 2a, reproduction signal processing circuit 60, disc motor control circuit 52, and system bus 7 are mounted on main body board 100. Note that FIG. 1 does not illustrate a pickup drive mechanism that translates pickup 3a with respect to the recording surface of optical disc 6.

Furthermore, drive control circuit 2a comprises first connector 22, controller 20a, signal generation circuit 8a, select signal generation circuit 82a, and control data generation circuit 83a. First connector 22 is connected to the plurality of signal lines 5. Controller 20a and control data generation circuit 83a are connected to system bus 7. The inputs of signal generation circuit 8a are connected to system bus 7, and its outputs are connected to first connector 22 and select signal generation circuit 82a. The inputs of select signal generation circuit 82a are connected to system bus 7, signal generation circuit 8a, and control data generation circuit 83a, and its outputs are connected to first connector 22.

Signal generation circuit 8a generates first and second current setting signal V1 and V2, and also generates first waveform control signal S1 and second waveform control signal S2 that masks or blinds first waveform control signal S1. Control data generation circuit 83a generates control data DATA, data transfer clock CLK, and output enable signal EN that instructs whether or not drive current ILD2 is generated, on the basis of data control signal DC and output control signal MODE, which are transferred from controller 20a via system bus 7. Select signal generation circuit 82a selects one of first waveform control signal S1 and control data DATA as first select signal SL1, and one of second waveform control signal S2 and data transfer clock CLK as second select signal SL2 on the basis of operation switching signal SW transferred from controller 20a via system bus 7. Controller 20a controls the operation timings of signal generation circuit 8a, select signal generation circuit 82a, control data generation circuit 83a, and the like.

Moreover, signal generation circuit 8a comprises laser amount control circuit 84a, recording signal processing circuit 80, and waveform control signal generation circuit 81a. Laser amount control circuit 84a is connected between system bus 7 and first connector 22. The input of recording signal processing circuit 80 is connected to system bus 7. The inputs of waveform control signal generation circuit 81a are connected to recording signal processing circuit 80 and system bus 7, and its output is connected to select signal generation circuit 82a. Recording signal processing circuit 80 modulates recording signal RD transferred from controller 20a via system bus 7. Waveform control signal generation circuit 81a generates first and second waveform control signals S1 and S2 on the basis of preset signal PD and modulated recording signal RD, which are transferred from controller 20a via system bus 7. Laser amount control circuit 84a generates first and second current setting signals V1 and V2 in accordance with voltage control signal VCTL, which is transferred from controller 20a via system bus 7.

### Supplementary Explanation of FIG. 1

Control in the time direction among signals to determine a plurality of timings requires high-precision control to cope with higher recording speed.

The number of signal lines connected to the pickup increases with increasing the number of functions of the pickup. An increase in the number of signal lines connected to the pickup makes a mechanical load heavier upon seeking the pickup. Also, since the number of connection points increases due to an increase in the number of signal lines, this results in product performance drop and reliability drop.

One signal line is used to determine the laser drive timings. Switching of laser outputs, switching of the laser current gains, switching of RF superposition, and the like are attained by the enable signal (EN) and serial I/Fs (SL1, SL2) by switching the laser current setting signals (V1, V2) and timing signals (S1, S2) by a selector, thus reducing the number of signal lines and attaining high-precision signal timings. When the laser current setting signal (V1, V2) changes to a predetermined level or less, a serial I/F (SL1, SL2) operation using the timing signal (S1, S2) is made.

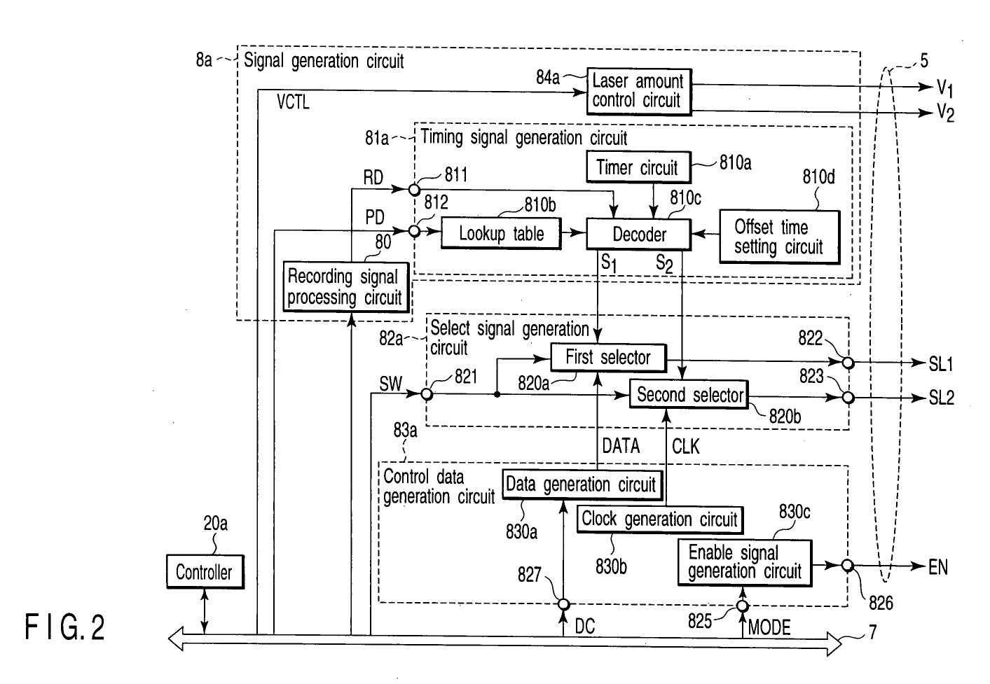

As shown in FIG. 2, the waveform control signal generation circuit 81a comprises recording data input terminal 811, preset signal input terminal 812, timer circuit 810a, lookup table 810b, decoder 810c, and offset time setting circuit 810d. The input of lookup table 810b is connected to preset signal input terminal 812. The inputs of the decoder 810c are connected to timer circuit 810a, lookup table 810b, and offset time setting circuit 810d. Note that the first connector 22 shown in FIG. 1 is not shown in FIG. 2.

Timer circuit 810a generates time information. Lookup table 810b generates a timing control signal used to finely adjust the timings of the leading and trailing edges of first and second waveform control signals S1 and S2 on the basis of preset signal PD. Offset time setting circuit 810d generates an offset control signal that controls the high-level duration of second waveform control signal S2. Offset time setting circuit 810d sets, e.g., the leading edge of second waveform control signal S2 before that of first waveform control signal S1, and sets the trailing edge of second waveform control signal S2 after that of first waveform control signal S1. Decoder 810c generates first and second waveform control signals S1 and S2 on the basis of modulated recording signal RD, the time information from timer circuit 810a, the timing control signal from lookup table 810b, and the offset control signal from offset time setting circuit 810d.

Furthermore, control data generation circuit 83a comprises data control signal input terminal 827, output control signal input terminal 825, enable signal output terminal 826, data generation circuit 830a, clock generation circuit 830b, and enable signal generation circuit 830c. Data generation circuit 830a is connected to data control signal input terminal 827. Enable signal generation circuit 830c is connected between output control signal input terminal 825 and enable signal output terminal 826. Data generation circuit 830a generates control data DATA in accordance with data control signal DC. Clock generation circuit 830b generates data transfer clock CLK. Enable signal generation circuit 830c generates output enable signal EN in accordance with output control signal MODE.

Select signal generation circuit 82a comprises operation switching signal input terminal 821, first select signal output terminal 822, second select signal output terminal 823, first selector 820a, and second selector 820b. The inputs of first selector 820a are connected to decoder 810c, operation switching signal input terminal 821, and data generation circuit 830a, and its output is connected to first select signal output terminal 822. The inputs of second selector 820b are connected to decoder 810c, operation switching signal input terminal 821, and clock generation circuit 830b, and its output is connected to second select signal output terminal 823. First selector 820a generates first select signal SL1 by selecting one of first waveform control signal S1 and control data DATA in accordance with operation switching signal SW. Second selector 820b generates second select signal SL2 by selecting one of second waveform control signal S2 and data transfer clock CLK in accordance with operation switching signal SW.

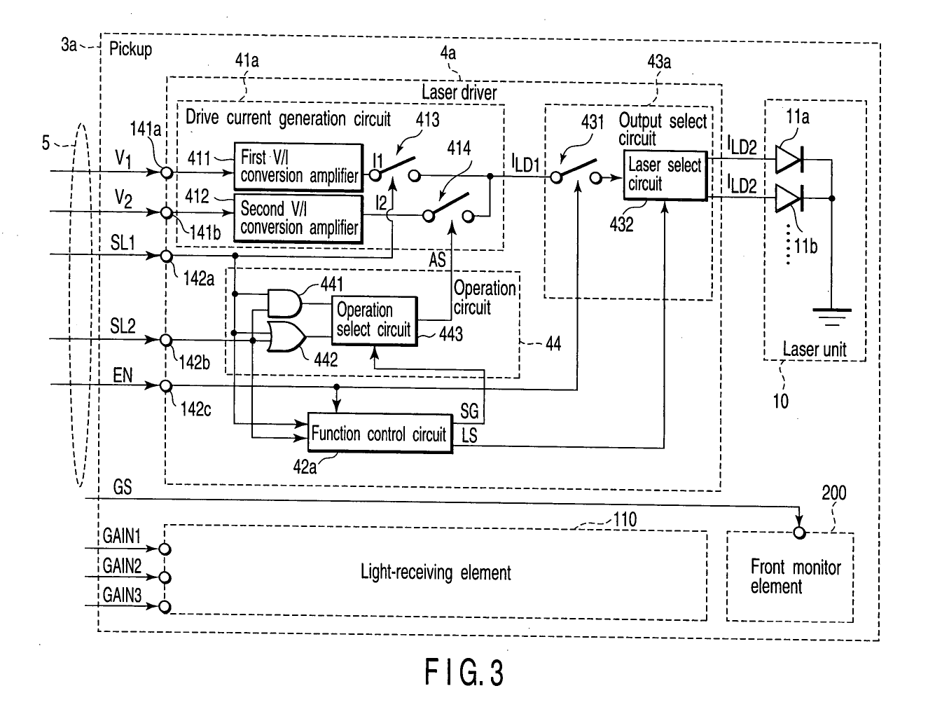

On the other hand, pickup 3a comprises second connector 31 connected to the plurality of signal lines 5, laser driver 4a connected to second connector 31, and laser unit 10 connected to laser driver 4a, as shown in FIG. 1. Laser driver 4a generates drive current ILD2 on the basis of first and second current setting signals V1 and V2, first and second select signals SL1 and SL2, and output enable signal EN. Laser unit 10 irradiates optical disc 6 with a laser beam in accordance with drive current ILD2. Note that laser unit 10 comprises a plurality of semiconductor laser elements 11a, 11b, . . . , the anodes of which are connected to laser driver 4a, and the cathodes of which are connected to ground VSS, as shown in FIG. 3.

Furthermore, laser driver 4a comprises first current setting signal terminal 141a, second current setting signal terminal 141b, first select signal terminal 142a, second select signal terminal 142b, enable signal terminal 142c, function control circuit 42a, operation circuit 44, drive current generation circuit 41a, and output select circuit 43a, as shown in FIG. 3. The inputs of function control circuit 42a are connected to first select signal terminal 142a, second select signal terminal 142b, and enable signal terminal 142c. The inputs of operation circuit 44 are connected to first select signal terminal 142a, second select signal terminal 142b, and the output of function control circuit 42a. The inputs of drive current generation circuit 41a are connected to first current setting signal terminal 141a, second current setting signal terminal 141b, first select signal terminal 142a, and the output of operation circuit 44. The inputs of output select circuit 43a are connected to enable signal terminal 142c, the output of function control circuit 42a, and the output of drive current generation circuit 41a, and its output is connected to laser unit 10. Note that second connector 31 shown in FIG. 1 is not shown in FIG. 3.

Function control circuit 42a generates operation select signal SG and laser select signal LS on the basis of first and second select signals SL1 and SL2, and output enable signal EN. Operation circuit 44 generates operation output signal AS by logically ANDing or ORing first and second select signals SL1 and SL2 in accordance with operation select signal SG. Drive current generation circuit 41a generates drive current ILD1 on the basis of first and second current setting signals V1 and V2, first select signal SL1, and operation output signal AS. Output select circuit 43a selects whether or not drive current ILD2 in accordance with output enable signal EN, and selects one of the plurality of semiconductor laser elements 11a, 11b, . . . used to emit a laser beam to which drive current ILD2 is to be supplied in accordance with laser select signal LS.

Furthermore, drive current generation circuit 41a comprises first voltage/current (V/I) conversion amplifier 411, second V/I conversion amplifier 412, first switch 413, and second switch 414. The input of first V/I conversion amplifier 411 is connected to first current setting signal terminal 141a. The input of second V/I conversion amplifier 412 is connected to second current setting signal terminal 141b. The inputs of first switch 413 are connected to fist select signal terminal 142a and the output of first V/I conversion amplifier 411, and its output is connected to output select circuit 43a. The inputs of second switch 414 are connected to the outputs of second V/I conversion amplifier 412 and operation circuit 44, and its output is connected to output select circuit 43a.

First V/I conversion amplifier 411 converts first current setting signal V1 into first current I1. Second V/I conversion amplifier 412 converts second current setting signal V2 into second current I2. First switch 413 switches whether or not to supply first current I1 to output select circuit 43a, in accordance with first select signal SL1. Second switch 414 switches whether or not to supply second current I2 to output select circuit 43a, in accordance with operation output signal AS.

Furthermore, operation circuit 44 comprises mask operation AND circuit 441, the inputs of which are connected to first and second select signal terminals 142a and 142b, mask operation OR circuit 442, the inputs of which are connected to first and second select signal terminals 142a and 142b, and operation select circuit 443, the inputs of which are connected to mask operation AND circuit 441, mask operation OR circuit 442, and function control circuit 42a, and the output of which is connected to second switch 414. Mask operation AND circuit 411 logically ANDs first and second select signals SL1 and SL2. By contrast, mask operation OR circuit 442 logically ORs first and second select signals SL1 and SL2. Operation select circuit 443 selects one of the output signal from mask operation AND circuit 441 and that from mask operation OR circuit 442 as operation output signal AS in accordance with operation select signal SG.

Output select circuit 43a comprises output switch 431, the inputs of which are connected to first switch 413, second switch 414, and enable signal terminal 142c, and laser select circuit 432, the inputs of which are connected to the output of output switch 431 and the output of function control circuit 42a, and the outputs of which are connected to the plurality of semiconductor laser elements 11a, 11b, . . . . Output switch 431 selects whether or not to output drive current ILD2, on the basis of output enable signal EN. Laser select circuit 432 selects one of the plurality of semiconductor laser elements 11a, 11b, . . . to which drive current ILD2 is to be supplied, on the basis of laser select signal LS.

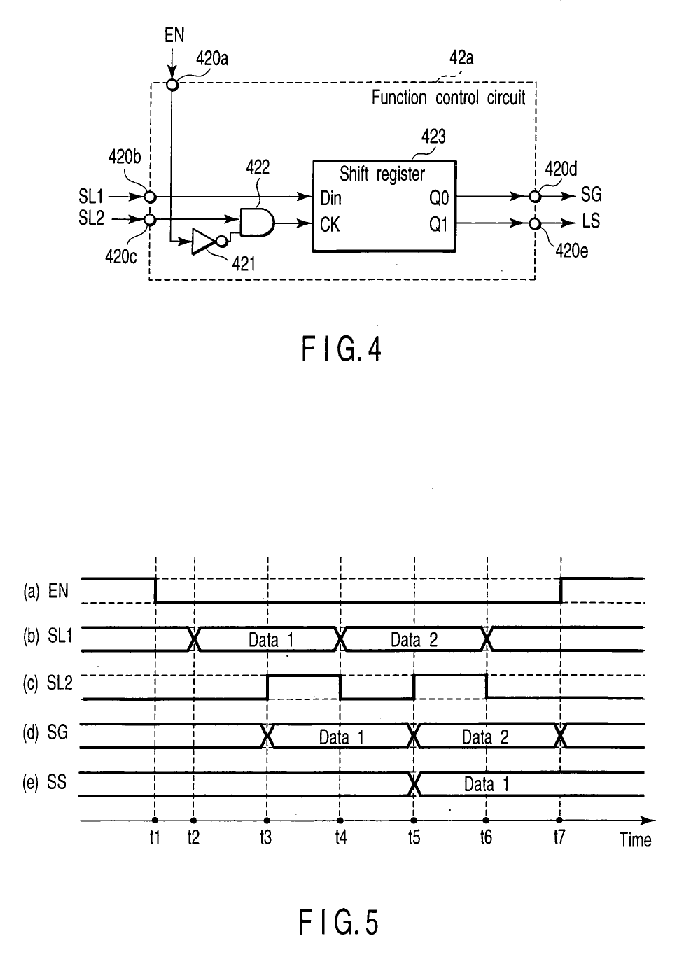

Furthermore, function control circuit 42a comprises first input terminal 420a, second input terminal 420b, third input terminal 420c, first output terminal 420d, second output terminal 420e, function control inverter 421, function control AND circuit 422, and shift register 423, as shown in FIG. 4. The input of function control inverter 421 is connected to first input terminal 420a. The inputs of function control AND circuit 422 are connected to third input terminal 420c and the output of function control inverter 421. Data input terminal Din of shift register 423 is connected to second input terminal 420b, clock terminal CK is connected to function control AND circuit 422, first data output terminal Q0 is connected to first output terminal 420d, and second data output terminal Q1 is connected to second output terminal 420e. Function control inverter 421 inverts output enable signal EN. Function control AND circuit 422 logically ANDs second select signal SL2 and inverted output enable signal EN. As a result, if output enable signal EN is at high level, second select signal SL2 is controlled not to be supplied to clock terminal CK of shift register 423. Shift register 423 generates operation select signal SG and laser select signal LS by shifting first select signal SL1 in synchronism with the output signal from function control AND circuit 422.

The operation of laser control unit 1a according to the first embodiment will be described below using FIGS. 1 to 6.

(A) At time t1 in FIG. 5(a), enable signal generation circuit 830c shown in FIG. 2 generates output enable signal EN of low level in accordance with output control signal MODE. Output enable signal EN is supplied to function control circuit 42a and output switch 431 shown in FIG. 3. Output switch 431 is turned off in response to output enable signal EN. Therefore, drive current ILD2 is maintained at a constant value, i.e., about 0 [A]. Furthermore, during the interval from times t1 to t2 in FIG. 5(b), data generation circuit 830a shown in FIG. 2 supplies control data DATA to first selector 820a. Clock generation circuit 830b supplies data transfer clock CLK to second selector 820b.

(B) At time t2 in FIG. 5(b), first selector 820a selects control data DATA as first select signal SL1 in accordance with operation switching signal SW. Second selector 820b selects data transfer clock CLK as second select signal SL2 in accordance with operation switching signal SW at time t2 in FIG. 5(c). First select signal SL1 is supplied to mask operation AND circuit 441, mask operation OR circuit 442, function control circuit 42a, and first switch 413 shown in FIG. 3. Second select signal SL2 mask operation AND circuit 441, mask operation OR circuit 442, and function control circuit 42a.

(C) Function control inverter 421 shown in FIG. 4 inverts output enable signal EN of low level. Function control AND circuit 422 logically ANDs second select signal SL2 and output enable signal EN of high level. Shift register 423 fetches first select signal SL1 in synchronism with the output signal from function control AND circuit 422. As a result, as shown in time t3 in FIGS. 5(c) and 5(d), operation select signal SG is generated in synchronism with the leading edge of second select signal SLT. At time t5 in FIGS. 5(c) and 5(e), laser select signal LS is generated in synchronism with the leading edge of second select signal SL2.

(D) Operation select circuit 443 shown in FIG. 3 selects the output signal from, e.g. mask operation AND circuit 441 as operation output signal AS on the basis of operation select signal SG. Laser select circuit 432 selects one of the plurality of semiconductor laser elements 11a, 11b, . . . on the basis of laser select signal LS. Furthermore, enable signal generation circuit 830c shown in FIG. 2 changes output enable signal to high level at time t7 in FIG. 5(a). When output enable signal EN changes to high level, output switch 431 shown in FIG. 3 is turned on. Pickup 3a traces optical disc 6 to search for a recording start position for a predetermined period of time after time t7 in FIG. 5.

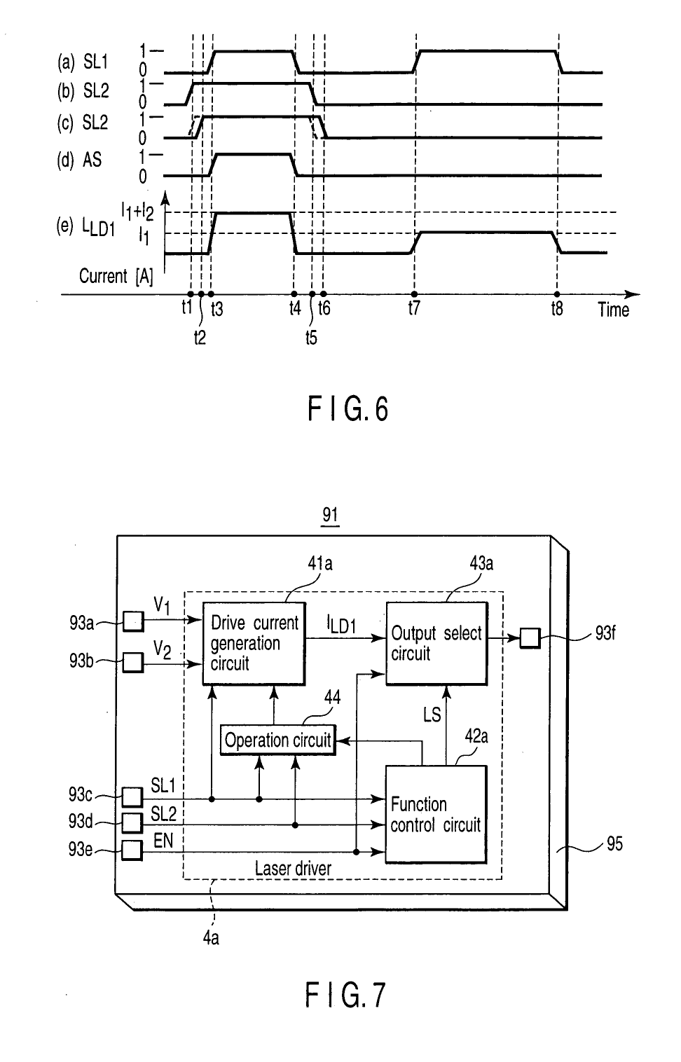

(E) First selector 820a shown in FIG. 2 selects first waveform control signal S1 from decoder 810c as first select signal SL1, as shown in FIG. 6(a). Second selector 820b selects second waveform control signal S2 from decoder 810c as second select signal SL2, as shown in FIG. 6(b). Laser amount control circuit 84a generates first and second current setting signals V1 and V2 having predetermined voltage values in accordance with voltage control signal VCTL. First and second current setting signals V1 and V2 are respectively supplied to first and second V/I conversion amplifiers 411 and 412 shown in FIG. 3. As a result, first and second currents I1 and I2 are generated.

(F) First and second select signals SL1 and SL2 are supplied to pickup 3a via the plurality of signal lines 5. Assume that second waveform control signal S2 suffers a signal delay during periods between times t1 and t2 and between t5 and t6 in FIG. 6(c) when it passes through the plurality of signal lines 5. First and second select signals SL1 and SL2 are logically ANDed by mark operation AND circuit 441 shown in FIG. 3. As a result, operation output signal AS shown in FIG. 6(d) is generated. First select signal SL1 is supplied to first switch 413. Operation output signal AS is supplied to second switch 414.

(G) First switch 413 is turned on during high-level periods of first select signal SL1, i.e., the period between times t3 and t4 in and that between times t7 and t8 in FIG. 6(a). By contrast, second switch 414 is turned on during a high-level period of operation output signal AS, i.e., the period between times t7 and t8 in FIG. 6(d). As a result, as shown in FIG. 6(e), the current value of drive current ILD2 becomes equal to the sum of the current values of first and second currents I1 and I2 during the period between t3 and t4. Also, the current value of drive current ILD2 becomes equal to that of first current I1 during the period between times t7 and t8. Therefore, drive current ILD2 has a pulse-shaped waveform in the recording mode.

Laser control unit 1a according to the first embodiment supplies control data DATA and data transfer clock CLK as first and second select signals SL1 and SL2 to pickup 3a during the period from time t1 to time t7 in FIG. 5 in which output enable signal EN is at low level, i.e., in a standby mode of the optical disc apparatus. In this manner, since the function of pickup 3a can be controlled in the standby mode, no function control signal need be added to the plurality of signal lines 5. Therefore, multi-functional pickup 3a can be supported without increasing the number of the plurality of signal lines 5, i.e., the number of signal lines of the flexible cable. By contrast, first waveform control signal S1 and second waveform control signal S2 that masks or blinds first waveform control signal S1 are supplied as first and second select signals SL1 and SL2 to pickup 3a in the recording mode. Hence, even when any signal delay has occurred in the plurality of signal lines 5, drive current ILD2 does not suffer any waveform distortion, thus realizing a recording operation with very high reliability.

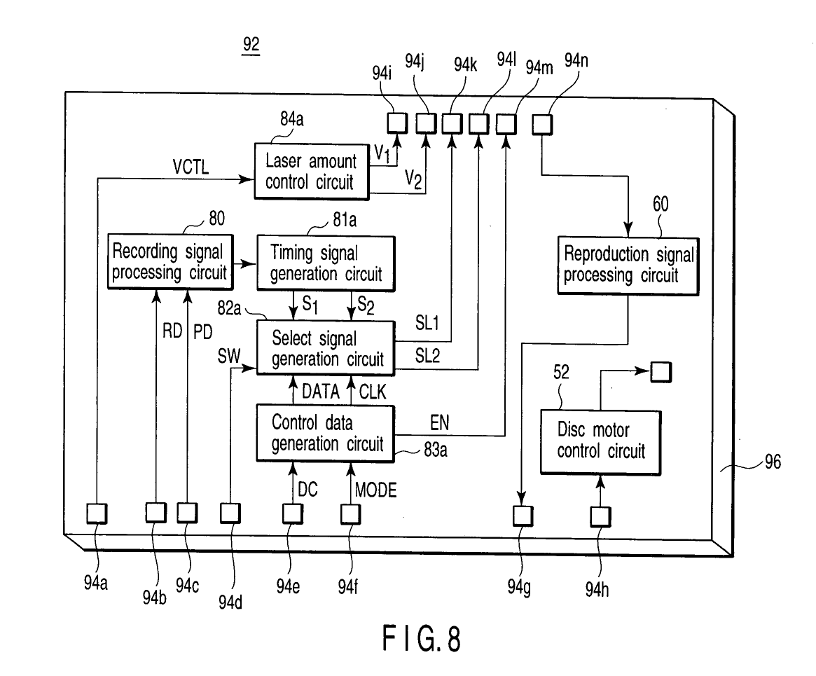

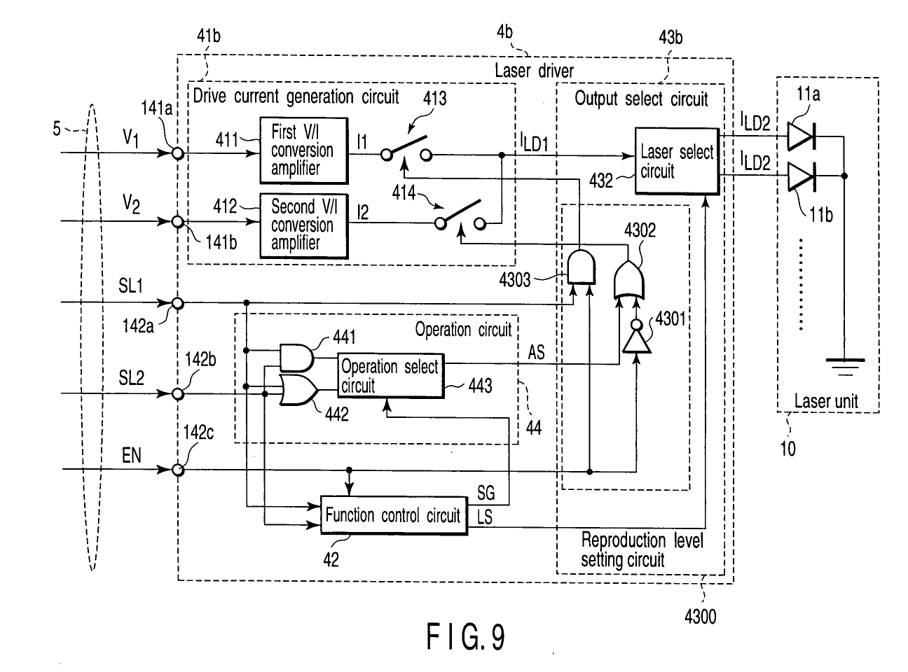

Furthermore, laser driver 4a shown in FIG. 1 can be monolithically integrated on single semiconductor chip 95 to form semiconductor integrated circuit 91, as shown in FIG. 7. In the example shown in FIG. 7, a plurality of bonding pads 93a to 93f are formed on semiconductor chip 95. Also, laser amount control circuit 84a, recording signal processing circuit 80, waveform control signal generation circuit 81a, select signal generation circuit 82a, control data generation circuit 83a, reproduction signal processing circuit 60, and disc motor control circuit 52 shown in FIG. 1 can be monolithically integrated on single semiconductor chip 96 to form semiconductor integrated circuit 92, as shown in FIG. 8. In the example shown in FIG. 8, a plurality of bonding pads 94a to 94n are formed on semiconductor chip 96.

### First Modification of First Embodiment

As laser driver 4b according to the first modification of the first embodiment, output select circuit 43b may further comprise reproduction level setting circuit 4300 that sets the current value of drive current ILD2 to be equal to a reproduction level, as shown in FIG. 9. Reproduction level setting circuit 4300 comprises level control inverter 4301, level control OR circuit 4302, level control AND circuit 4303. Level control inverter 4301 is connected between enable signal terminal 142c and the one input of level control OR circuit 4302. The other input of level control OR circuit 4302 is connected to operation select circuit 443, and its output is connected to second switch 414. One input of level control AND circuit 4303 is connected to enable signal terminal 142c, its other input is connected to first select signal terminal 142a, and its output is connected to first switch 413.

Level control inverter 4301 inverts output enable signal EN. Level control OR circuit 4302 logically Ors inverted output enable signal EN and operation output signal AS to control second switch 414. Level control AND circuit 4303 logically ANDs first select signal SL1 and output enable signal EN to control first switch 413.

As a result, when output enable signal EN is at low level, first switch 413 is turned off, and second switch 414 is turned on. Hence, by controlling the voltage value of second current setting signal V2 to the reproduction level, the current amount of drive current ILD2 can be set at the reproduction level. In this way, according to laser driver 4b shown in FIG. 9, the current value of drive current ILD2 can be set at a constant value.

### Second Modification of First Embodiment

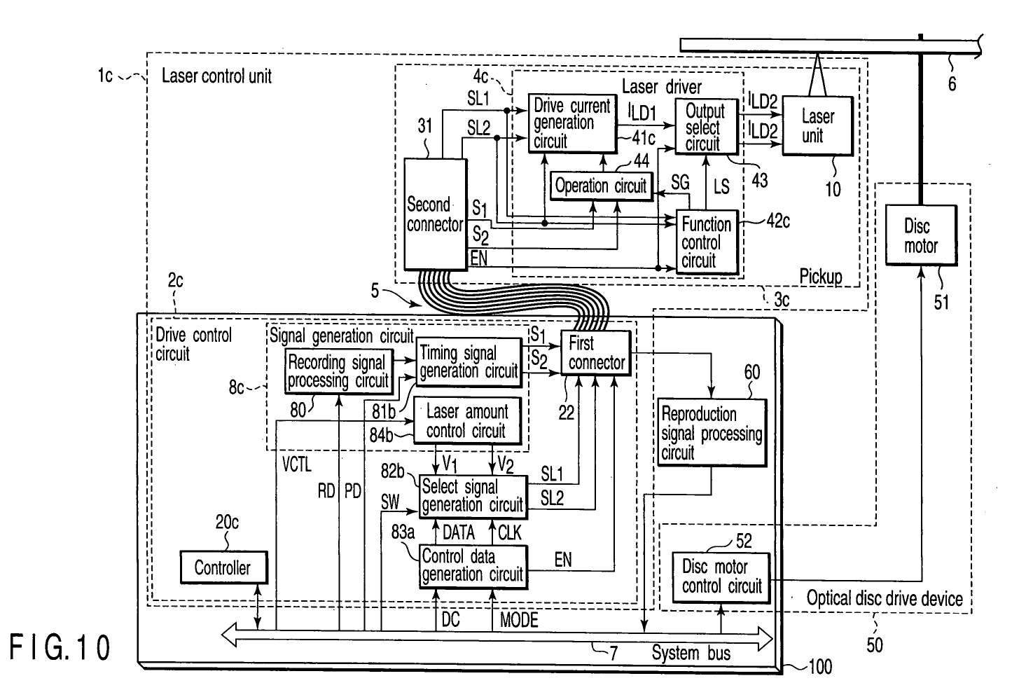

As an optical disc apparatus according to the second modification of the first embodiment, laser amount control circuit 84b may be connected to select signal generation circuit 82b, as shown in FIG. 10. Select signal generation circuit 82b selects one of first current setting signal V1 and control data DATA as first select signal SL1 on the basis of switching signal SW, and selects one of second current setting signal V2 and data transfer clock CLK as second select signal SL2. First and second select signals SL1 and SL2 are supplied to drive current generation circuit 41c and function control circuit 42c via first connector 22, the plurality of signal lines 5, and second connector 31.

First waveform control signal S1 generated by waveform control signal generation circuit 81b is supplied to drive current generation circuit 41c and operation circuit 44 via first connector 22, the plurality of signal lines 5, and second connector 31. Second waveform control signal S2 is supplied to operation circuit 44 via first connector 22, the plurality of signal lines 5, and second connector 31. According to the optical disc apparatus shown in FIG. 10, multi-functional pickup 3a can be supported without increasing the number of the plurality of signal lines 5, i.e., the number of signal lines of the flexible cable.

### Third Modification of First Embodiment

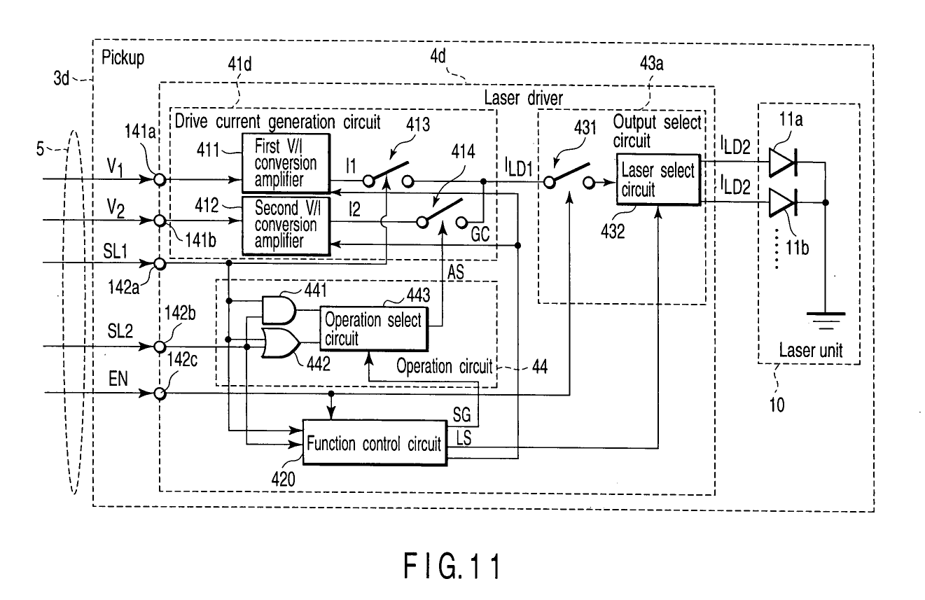

As pickup 3d according to the third modification of the first embodiment, function control circuit 420 may further control the current gain of drive current generation circuit 41d, as shown in FIG. 11. Function control circuit 420 supplies gain control signal GC to first and second V/I conversion amplifiers 411 and 412. According to pickup 3d shown in FIG. 11, the current gain of drive current generation circuit 41d can be increased in a high-speed recording mode.

### Second Embodiment

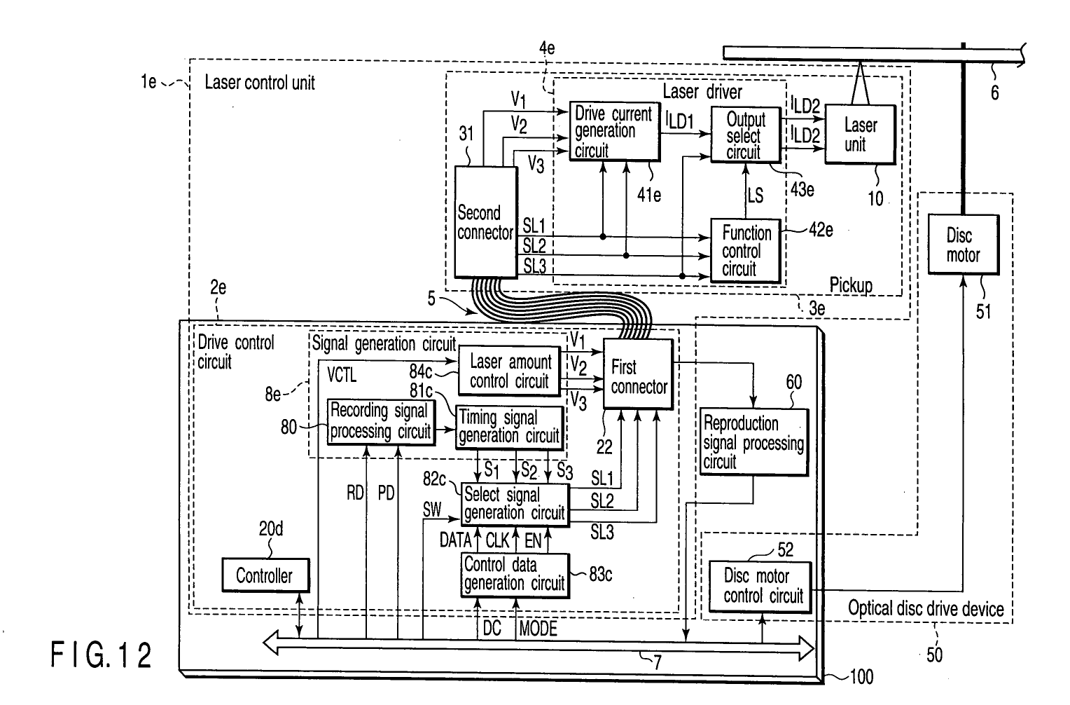

In an optical disc apparatus according to the second embodiment of the present invention, waveform control signal generation circuit 81c further generates third waveform control signal S3, as shown in FIG. 12, unlike in FIG. 1. Control data generation circuit 83c supplies output enable signal EN to select signal generation circuit 82c unlike in FIG. 1. Select signal generation circuit 82c further generates third select signal SL3 unlike in FIG. 1. Laser amount control circuit 84c further generates third current setting signal V3 unlike in FIG. 1. Laser driver 4e does not comprise any operation circuit 44 unlike in FIG. 1. Other building components are the same as those of the optical disc apparatus shown in FIG. 1. Each of laser driver 4e and drive control circuit 2e shown in FIG. 12 can be monolithically integrated on a single semiconductor chip to form a semiconductor integrated circuit, as in FIGS. 7 and 8.

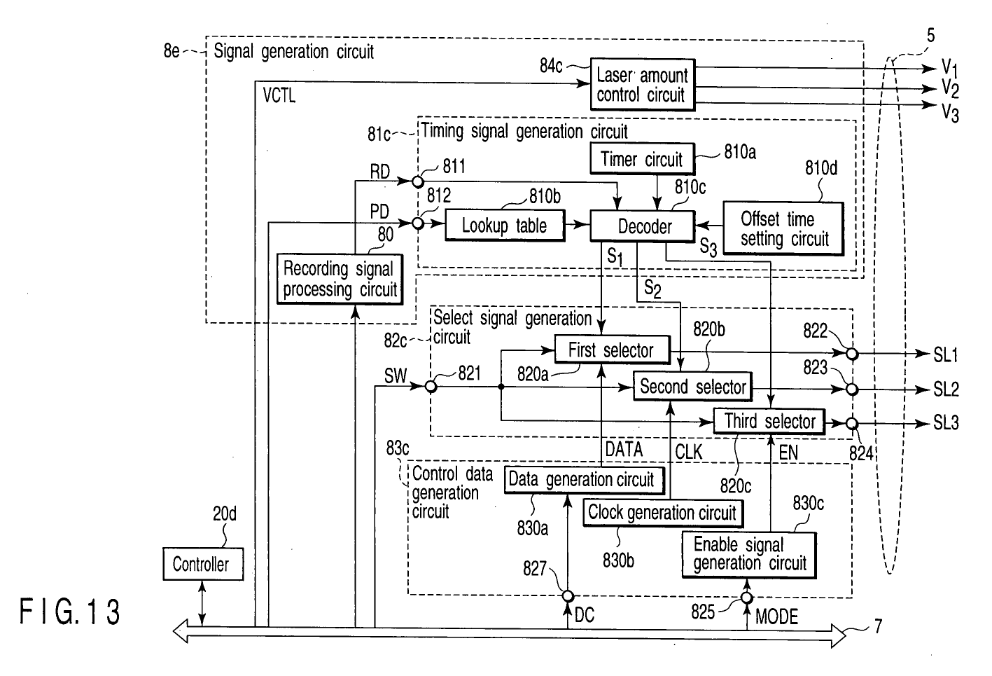

Select signal generation circuit 82c further comprises third selector 820c, the inputs of which are connected to operation switching signal terminal 821, decoder 810c, and enable signal generation circuit 830c, and the output of which is connected to third select signal output terminal 824, as shown in FIG. 13, unlike in FIG. 2. Third selector 820c selects one of third waveform control signal S3 from decoder 810c and output enable signal EN from enable signal generation circuit 830c as third select signal SL3.

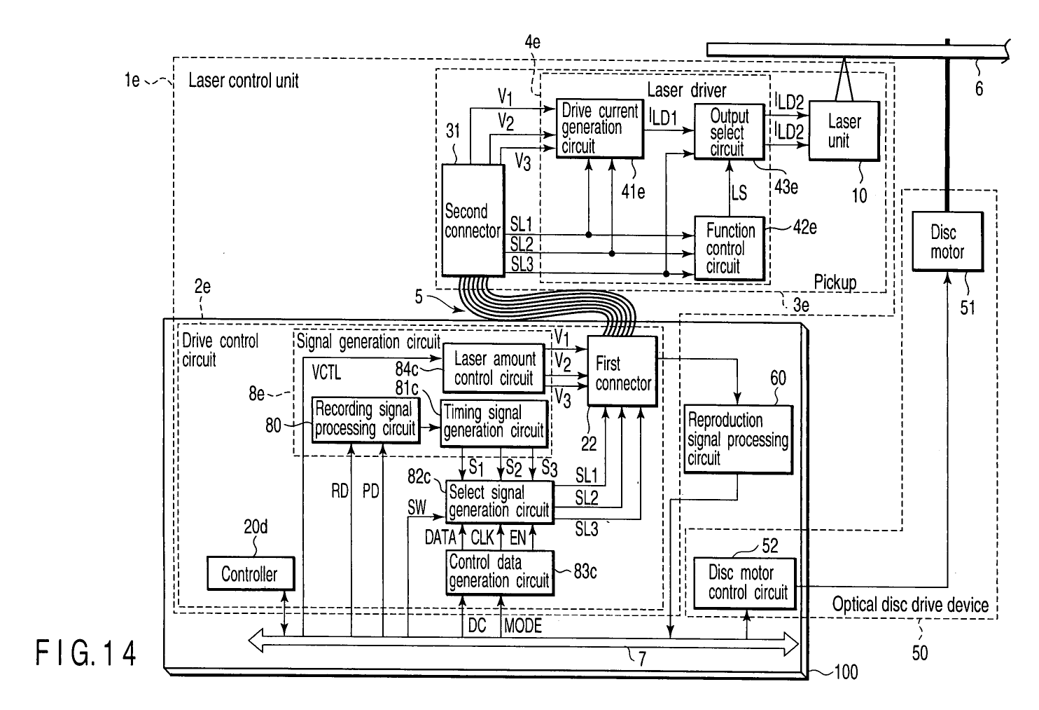

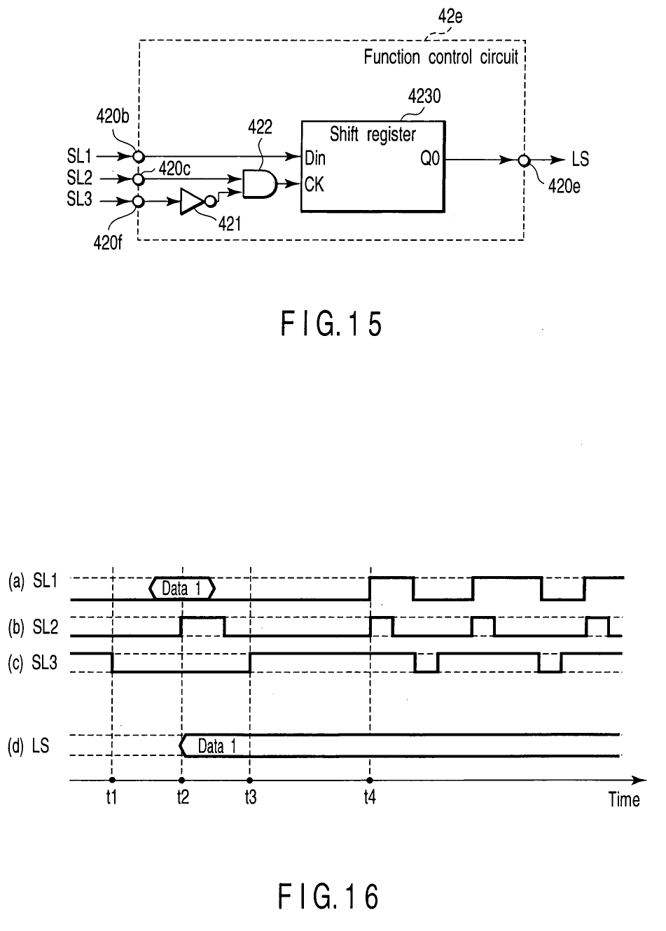

Furthermore, drive current generation circuit 41e further comprises third V/I conversion amplifier 415, the input of which is connected to third current setting signal terminal 141c and the output of which is connected to output switch 431, as shown in FIG. 14, unlike in FIG. 3. Third V/I conversion amplifier 415 generates third current I3 by V/I-converting third current setting signal V3. Function control circuit 42e does not generate any operation select signal SG, as shown in FIG. 15, unlike in FIG. 4.

The operation of laser control unit 1e according to the second embodiment will be described below using FIGS. 12 to 16. Note that a repetitive description of the same operations as those of laser control unit 1a according to the first embodiment will be omitted.

(A) At time t1 in FIG. 16, first selector 820a shown in FIG. 13 selects control data DATA as first select signal SL1 on the basis of switching signal SW. Likewise, second selector 820b selects data transfer clock CLK as second select signal SL2. Third selector 820c selects output enable signal EN as third select signal SL3. Enable signal generation circuit 830c generates output enable signal EN of low level. Laser amount control circuit 84c generates first, second, and third current setting signals V1, V2, and V3. First, second, and third current setting signals V1, V2, and V3 respectively undergo V/I conversion by first, second, and third V/I conversion amplifiers 411, 412, and 415 shown in FIG. 14. As a result, first, second, and third currents I1, I2, and I3 are generated.

(B) During the period between times t1 and t2 in FIG. 16(a), data generation circuit 830a generates control data DATA. Control data DATA is supplied to data input terminal Din of shift register 4230 shown in FIG. 15 as first select signal SL1. Furthermore, data transfer clock CLK changes to high level at time t2 in FIG. 16(b). Data transfer clock CLK is supplied to function control AND circuit 422 shown in FIG. 15 as second select signal SL2. Since third select signal SL3 is at low level at time t2 in FIG. 16, function control AND circuit 422 supplies second select signal SL2 to clock terminal CK of shift register 4230. Shift register 4230 latches first select signal SL1 in synchronism with the leading edge of second select signal SL2, as shown in FIG. 16(d). Latched first select signal SL1 is supplied to laser select circuit 432 shown in FIG. 14.

(C) At time t3 in FIG. 16, enable signal generation circuit 830c changes output enable signal EN to high level. As a result, third select signal SL3 changes to high level at time t3 in FIG. 16(c). When third select signal SL3 changes to high level, output switch 431 shown in FIG. 14 is turned on. As a result, third current I3 is supplied to laser unit 10 as drive current ILD2. Pickup 3e traces optical disc 6 to search for a recording start position for a period between times t3 and t4 in FIG. 16.

(D) At time t4 in FIG. 16, first and second select signals SL1 and SL2 change to high level. When first and second select signals SL1 and SL2 change to high level, first and second switches 413 and 414 shown in FIG. 14 are turned on. As a result, the laser beam generated by laser unit 10 has a maximum level. During the period after time t4 in FIG. 16, i.e., in a recording mode, a combination of first and second select signals SL1 and SL2 is controlled not to operate function control circuit 42e shown in FIG. 15. Therefore, a state wherein first select signal SL1 changes to high level and second select signal SL2 changes to low level is inhibited, as shown in FIGS. 16(a) and 16(b).

As described above, according to the second embodiment, since select signal generation circuit 82c selects one of third waveform control signal S3 and output enable signal EN as third select signal SL3, a signal line dedicated to output enable signal EN need not be added to the plurality of signal lines 5. Therefore, an increase in mount area of first and second connectors 22 and 31 and reliability drop due to an increase in size of the flexible cable can be prevented.

### Third Embodiment

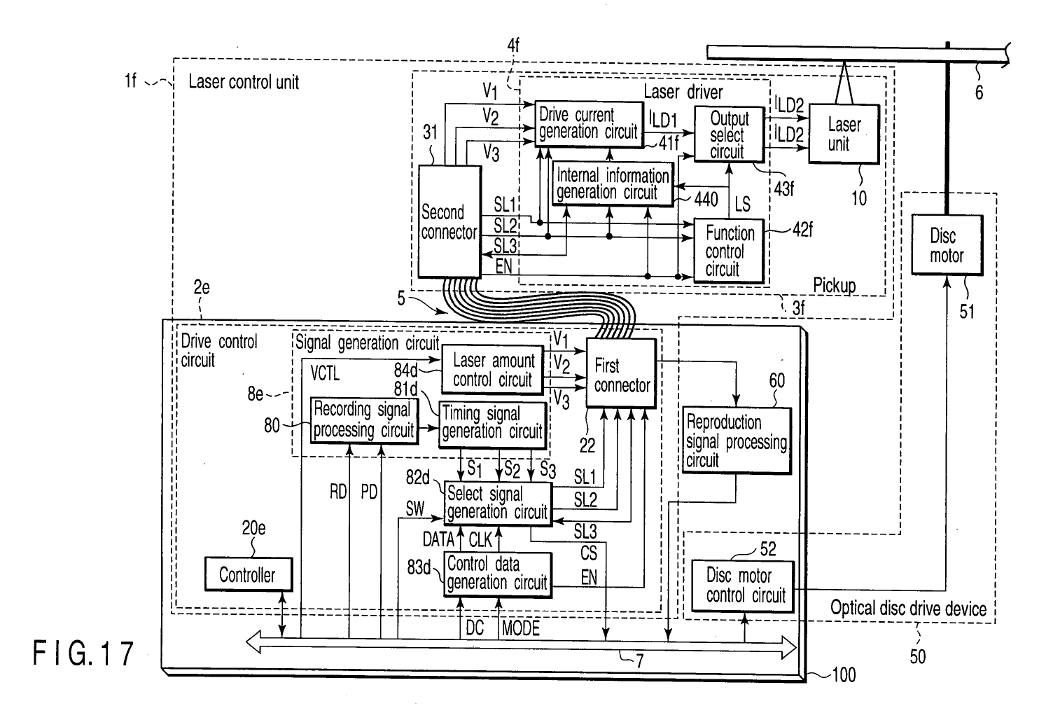

In an optical disc apparatus according to the third embodiment of the present invention, as shown in FIG. 17, laser driver 4f comprises internal information generation circuit 440 that detects a data transfer error of control data DATA, unlike in FIG. 1. Internal information generation circuit 440 calculates, e.g., a checksum of laser select signal LS, and supplies error detection signal CS to select signal generation circuit 82d as third select signal SL3. Other components are the same as those of the optical disc apparatuses shown in FIGS. 1 and 12.

Furthermore, internal information generation circuit 440 comprises checksum calculation circuit 440a, third select signal switch 440b, and detection signal select switch 440c. Checksum calculation circuit 440a is connected between the output of function control circuit 42f and the input of detection signal select switch 440c. The inputs of third select signal switch 440b are connected to third select signal terminal 142c and enable signal terminal 142d, and its output is connected to third switch 416. The inputs of detection signal select switch 440c are connected to checksum calculation circuit 440a and enable signal terminal 142d, and its output is connected to third select signal terminal 142c.

Checksum calculation circuit 440a generates error detection signal CS by calculating the checksum of laser select signal LS. Third select signal switch 440b selects whether or not to supply third select signal SL3 to third switch 416, on the basis of output enable signal EN. Detection signal select switch 440c selects whether or not to supply error detection signal CS to third select signal terminal 142c, on the basis of output enable signal EN.

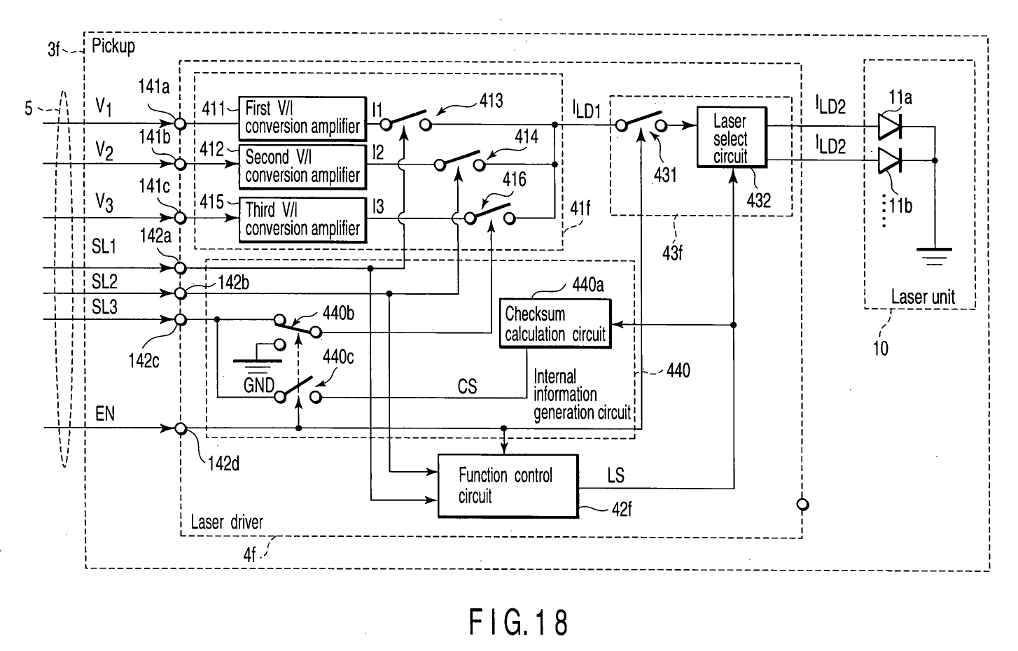

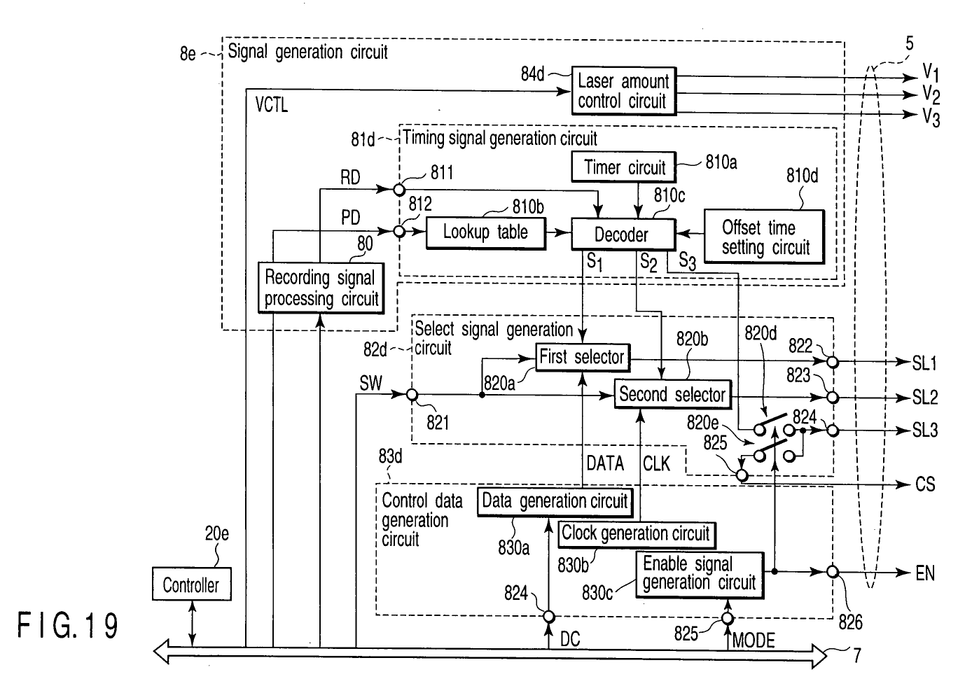

Furthermore, select signal generation circuit 82d further comprises third waveform control signal output switch 820d and third select signal input switch 820e, as shown in FIG. 19, unlike in FIG. 2. Third waveform control signal output switch 820d selects whether or not to supply third waveform control signal S3 to pickup 3f, on the basis of output enable signal EN. Third select signal input switch 820e selects whether or not to supply third select signal SL3 from internal information generation circuit 440 shown in FIG. 18 to controller 20e. Data generation circuit 830a calculates, e.g., the total value of control data DATA in advance, and appends the total value to control data DATA.

Third waveform control signal output switch 820d and third select signal switch 440b shown in FIG. 18 are turned on in response to output enable signal EN of high level. That is, in the recording mode, third waveform control signal output switch 820d and third select signal switch 440b are turned on. By contrast, third select signal input switch 820e and detection signal select switch 440c shown in FIG. 18 are turned on in response to output enable signal EN of low level. That is, in the standby or reproduction mode, third select signal input switch 820e and detection signal select switch 440c are turned on.

The operation of laser control unit 1f according to the third embodiment will be described below using FIGS. 17 to 20. Note that a repetitive description of the same operations as those of laser control unit 1a according to the first embodiment will be omitted.

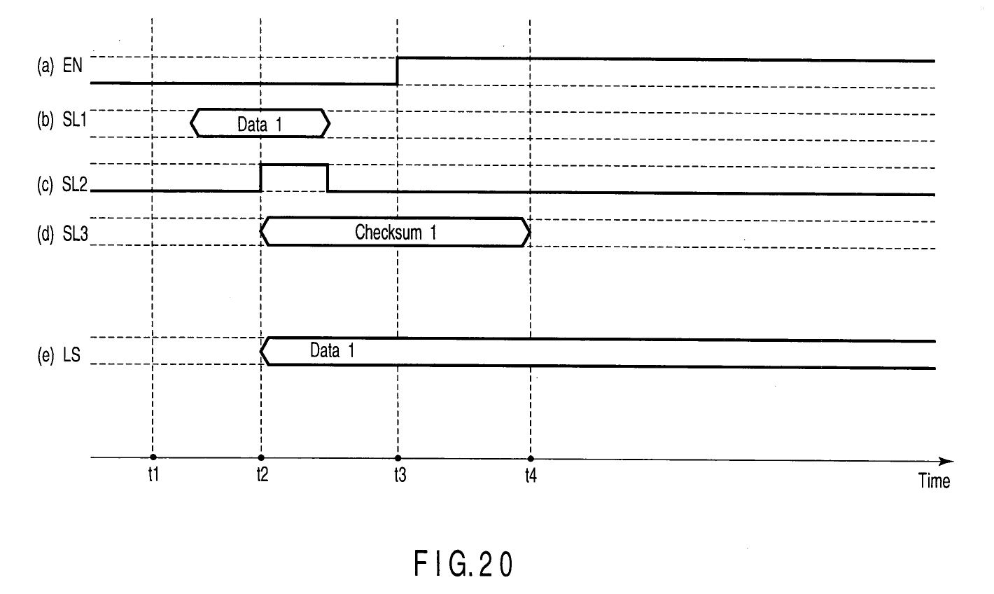

(A) At time t1 in FIG. 20(a), output enable signal EN changes to low level. When output enable signal EN changes to low level, detection signal select switch 440c shown in FIG. 18 and third select signal input switch 820e shown in FIG. 19 are turned on.

(B) During the period between times t1 and t2 in FIG. 20(a), control data DATA from data generation circuit 830a is supplied to function control circuit 42f shown in FIG. 18 as first select signal SL1. Furthermore, at time t2 in FIG. 20(c), data transfer clock CLK changes to high level. When data transfer clock CLK changes to high level, laser select signal LS is generated at time t2 in FIG. 20(e).

(C) Checksum calculation circuit 440a shown in FIG. 18 checks if laser select signal LS includes an error. For example, checksum calculation circuit 440a calculates the total of laser select signal LS, and compares it with the total value calculated by data generation circuit 830a. Checksum calculation circuit 440a generates error detection signal CS using the checksum, as shown in FIG. 20(d). Data generation circuit 830a transmits control data DATA again when it receives error detection signal CS.

(D) When output enable signal EN changes to high level at time t4 in FIG. 20(a), detection signal select switch 440c shown in FIG. 18 and third select signal input switch 820e shown in FIG. 19 are turned off.

As described above, according to the third embodiment, a data transfer error of control data DATA can be detected. Checksum calculation circuit 440a may directly calculate control data DATA input to function control circuit 42f in place of laser select signal LS.

### Modification of Third Embodiment

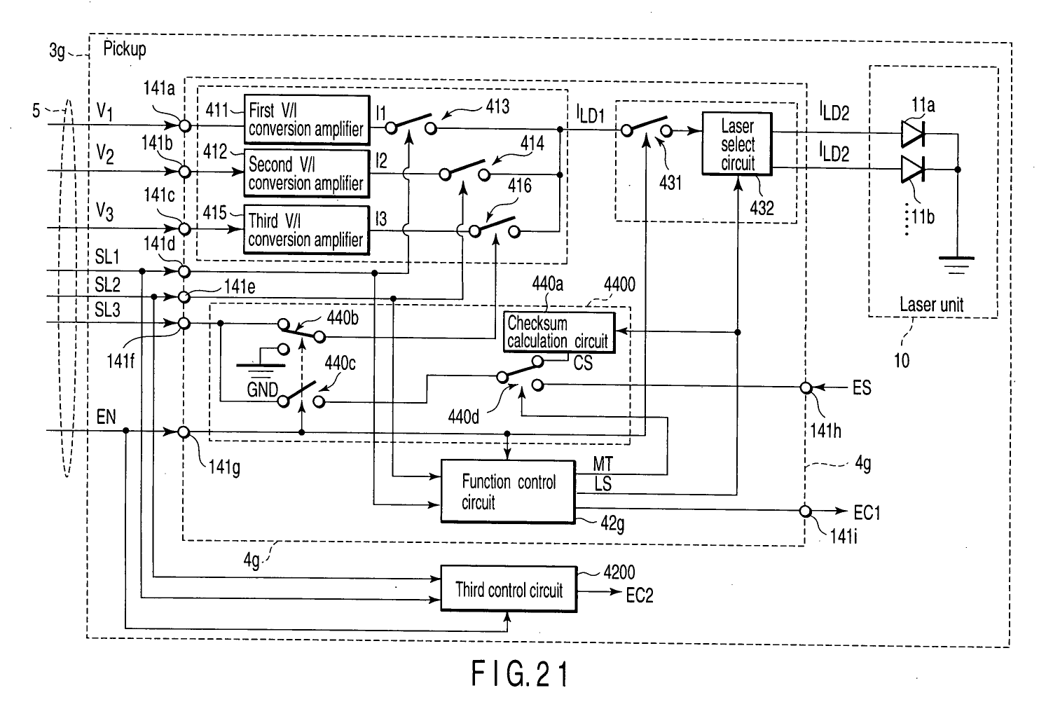

Pickup 3g according to a modification of the third embodiment may further comprise external control circuit 4200 that controls external circuits of laser driver 4g, as shown in FIG. 21. External control circuit 4200 generates external control signal EC on the basis of first and second select signals SL1 and SL2, and output enable signal EN. Also, function control circuit 42g may further generate internal information select signal MT. Furthermore, internal information generation circuit 4400 further comprises internal information select switch 440d that supplies one of error detection signal CS and external information ES supplied from the external circuits of laser driver 4g to detection signal select switch 440c on the basis of internal information select signal MT. According to pickup 3g shown in FIG. 21, not only the internal circuits of laser driver 4g but also the external circuits of laser driver 4g can be controlled.

In the first embodiment (FIGS. 1 to 8) described above, control data DATA is serially transferred in the standby mode. In the first modification (FIG. 9) of the first embodiment, control data DATA is serially transferred in the reproduction mode. However, control data DATA may be serially transferred in an arbitrary period of the standby and reproduction modes. Furthermore, when the number of the plurality of current setting signals V1, V2, . . . and the number of the plurality of waveform control signals S1, S2, . . . increase, control data DATA may be parallelly transferred in place of serial transfer (use of both serial transfer and parallel transfer). When the number of functions to be controlled increases, an increase in the number of functions can be coped with by increasing the number of stages of shift register 423 shown in FIG. 4.

In the first to third embodiments (FIGS. 1 to 21) that have already been described above, waveform control signal generation circuit 81d is formed using decoder 810c. However, pulse generation circuits corresponding to a plurality of waveform control signals S1, S2, . . . may be arranged in place of decoder 810c.

Furthermore, in the third embodiment, internal information generation circuit 440 comprises third select signal switch 440b and detection signal select switch 440c. However, by providing a sequence unit that operates in synchronism with data transfer clock CLK, third select signal switch 440b and detection signal select switch 440c may be omitted.

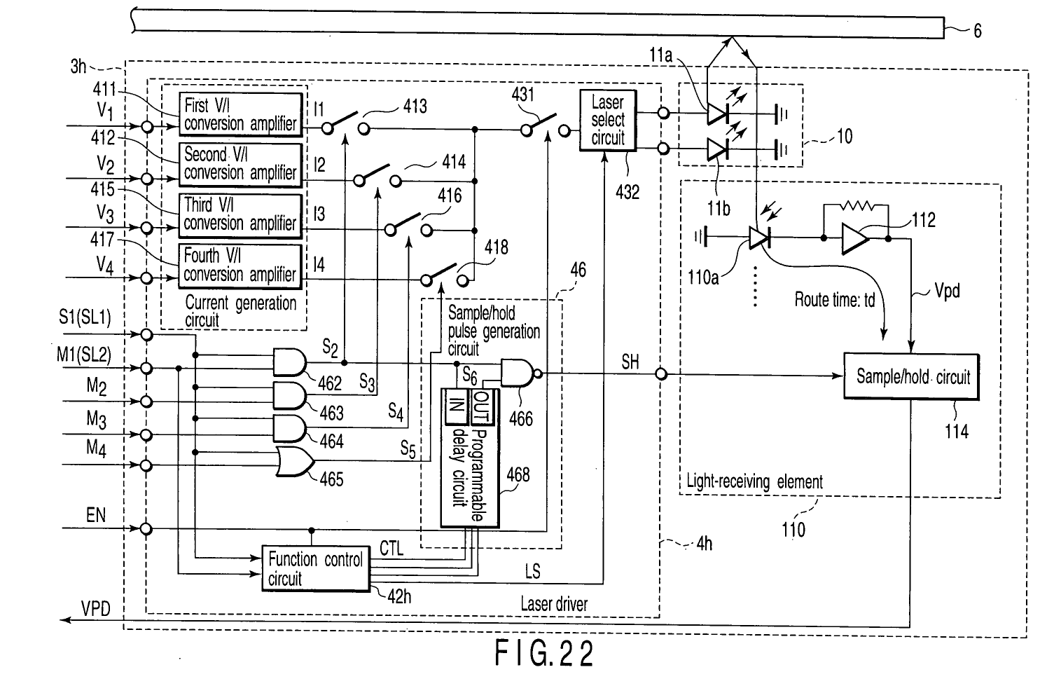

FIG. 22 is a block diagram showing an example of the arrangement of a laser pickup according to still another embodiment (fourth embodiment) of the present invention. In the optical disc apparatus shown in FIG. 1 and the like, since laser control in the recording operation mode is made on the basis of a plurality of timing signals which are supplied from drive control circuit 2 (digital signal processor DSP that integrates its functions) on circuit board 100 and are required to have high precision, delays of timing signals may influence the precision of recording pulses on pickup 3.

On the other hand, sample/hold pulse SH for light-receiving element output signal Vpd on pickup 3h in FIG. 22 requires fine adjustment in the DSP (2a in FIG. 1, 2c in FIG. 10, 2e in FIG. 12). Since the pulse shape of a laser control timing signal changes depending on recording media and recording conditions used, the timing of sample/hold pulse SH must be changed accordingly, resulting in a troublesome process. Signal distortion may occur from pickup 3h until the sample/hold operation on circuit board 100, thus disturbing the precise sample/hold operation. When sample/hold pulse SH is supplied to pickup 3h to improve distortion precision to execute the sample/hold operation in pickup 3h, the number of timing signal lines that require high precision increases in flexible cable 5, and causes noise.

To solve these problems, laser driver 4h on pickup 3h generates sample/hold pulse SH to be output to light-receiving element output signal Vpd during only the period in which an optical output is produced for reproduction or erasure, on the basis of the laser control timing signal (SL1, SL2, EN, or the like). Since circuit 114 performs the sample/hold operation in response to this pulse SH, the sample/hold precision can be improved.

In the arrangement shown in FIG. 22, sample/hold pulse SH is generated based on laser control timing signal S1 (SL1) transferred on pickup 3h. For this purpose, sample/hold generation circuit 46 which comprises programmable delay circuit 468 that can adjust a pulse delay amount based on control signal CTL from function control circuit 42h (corresponding to 42a in FIG. 1 and the like), and NAND circuit 466 is used.

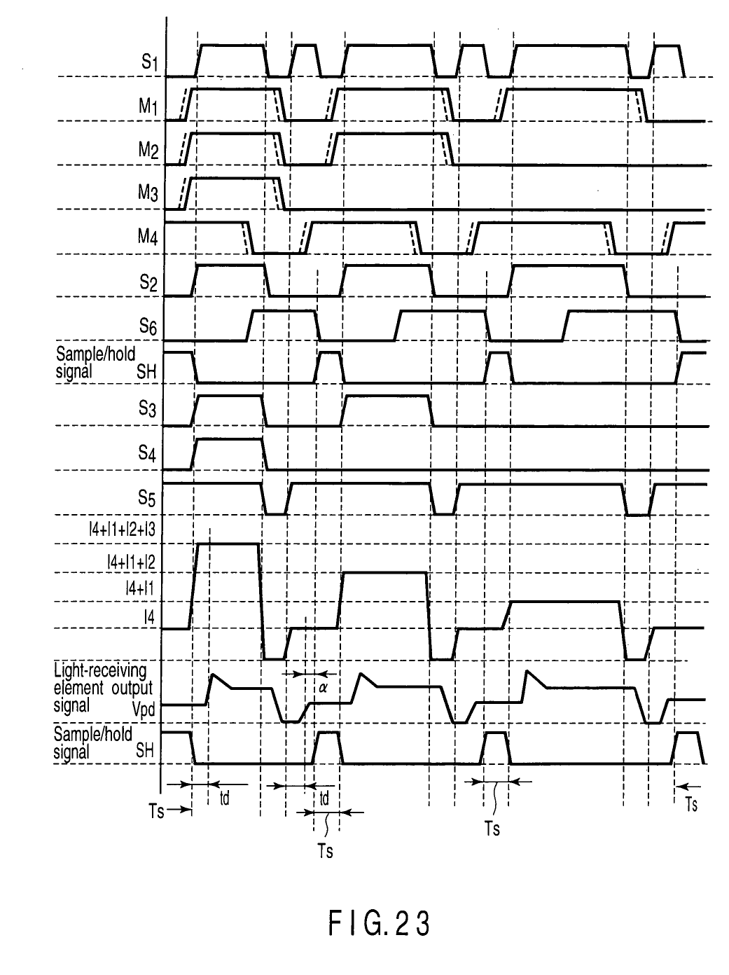

FIG. 23 is a timing chart for explaining the operation of the arrangement shown in FIG. 22. Delay circuit 468 is set based on signal S1 in consideration of time period td required from when a laser beam is emitted and is returned to light-receiving element 110, and signal S6 is generated by delaying signal S1 by time period td+α. When signals S1 and S6 are logically NANDed, sample/hold pulse SH can be generated during only the period (Ts in the example of FIG. 23) in which an optical output is produced for reproduction or erasure, with respect to light-receiving element output signal Vpd. Time period Td+α can be handled as an absolute time period which is independent from a recording multiple speed (a rate of increase in speed with respect to the normal recording speed), and the delay amount set in programmable delay circuit 468 can be determined uniquely (at the time of device design).

Since laser driver 4h on pickup 3h generates sample/hold pulse SH from the laser control timing signal, an increase in the number of signal lines as transfer paths of flexible cable 5 to pickup 3h can be avoided.

The sample/hold operation is made near light-receiving element output vpd (in FIG. 22, sample/hold circuit 114 is mounted in a device of light-receiving element 110, which also includes photodiode 110a). For this reason, a high-precision sample/hold operation which suffers less distortion (upon signal transfer over a long distance) can be attained.

Sample/hold pulse SH is generated on pickup 3h from one laser control timing signal (S1 or SL1). For this reason, since the generation timing of sample/hold pulse SH is automatically changed depending on changes in recording medium and recording conditions, no troublesome adjustment is required.

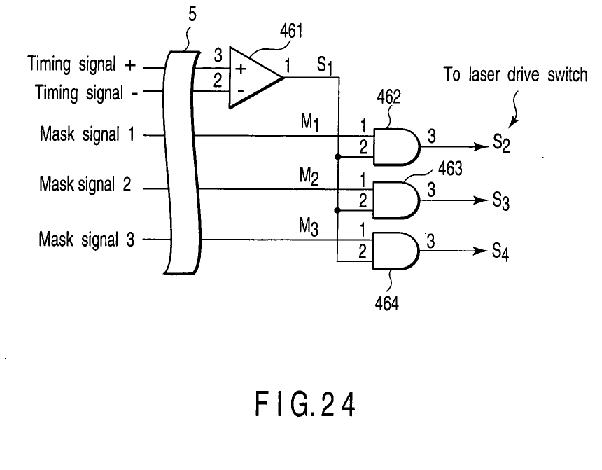

FIG. 24 is a diagram for explaining an example of the arrangement when a pair of timing signals are differentially transferred and a plurality of masking signals are non-differentially transferred in signal transfer of a flexible cable based on a trimming pulse scheme. This arrangement example uses a plurality of flexible signal lines 5 which transfers, to pickup 3, timing signal S1 that controls the laser output timing, and masking signals M1 to M3 that mask or blind this timing signal as at least some components of control information of laser drive current ILD2, a drive circuit (2 in FIG. 1 and the like) which serially transfers masking signals M1 to M3 using at least one (three in this case) of the plurality of signal lines 5 to pickup 3.

Note that signal lines that transfer timing signal S1 (a pair of timing signals + and −) comprise a pair differential signal transfer lines (a pair of two lines), and a signal line that transfers a masking signal (e.g., mask signal 1) comprises one non-differential signal transfer line. Flexible signal lines 5 comprise the non-differential signal transfer lines, the number of which is much larger than the pair of differential signal transfer lines. Since each non-differential signal transfer line requires the number of signal lines half that of the differential signal transfer line, the signal line number suppression effect of flexible cable 5 is relatively enhanced with increasing number of non-differential signal transfer lines that replace differential signal transfer lines.

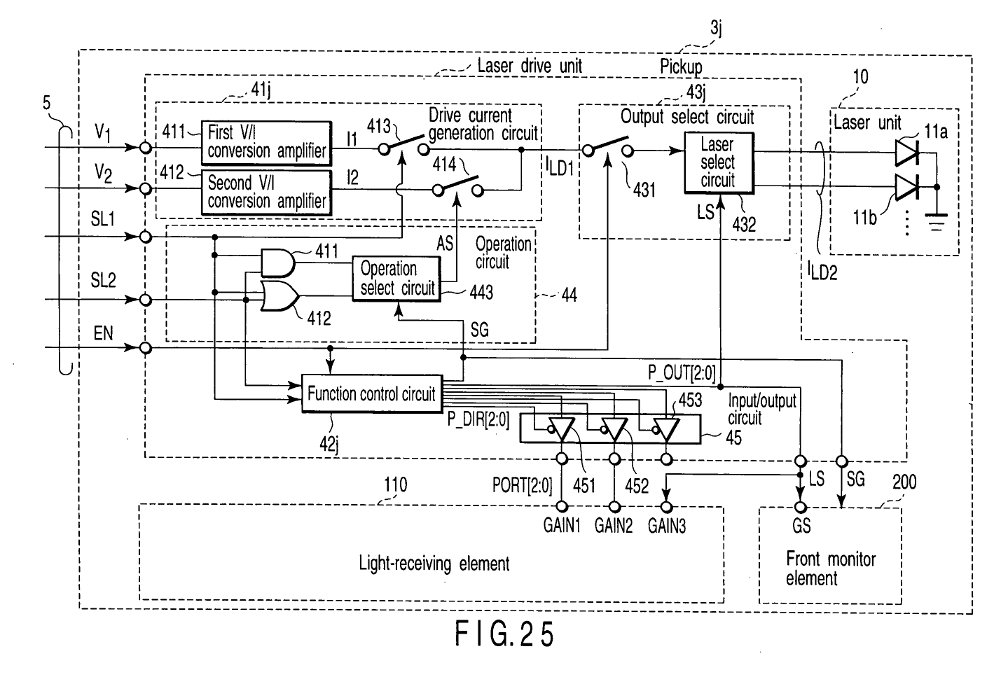

FIG. 25 is a block diagram showing an example of a laser pickup according to still another embodiment (fifth embodiment) of the present invention. A pickup is required to have more functions to cope with higher recording density, diversity of recording media, higher recording speed, and the like. A large number of signal lines for function control must be assured in flexible cable 5. As a result, the number of signal lines of flexible cable 5 increases, and problems of an increase in mount area and reliability drop of a connector connected to the flexible cable are posed in addition to a problem of an increase in mechanical load on pickup 3.

In the embodiments of FIG. 1 and the like, a laser control signal is used for function control during only a predetermined period, while in the example of FIG. 25, a control signal is output outside a laser drive unit, and function control of elements (light-receiving element 110, front monitor element 200 in the example of FIG. 25) other than the drive unit is made based on that output. In this manner, the number of signal lines for function control, which are conventionally controlled by a versatile port or the like of a CPU (or DSP) on main body board 100 via flexible cable 5 can be reduced.

In the example of FIG. 25, the arrangement of principal electric parts in pickup 3j includes a laser drive unit, laser unit 10, light-receiving element 110, and front monitor 200. Furthermore, the laser drive unit comprises drive current generation circuit 41j, function control circuit 42j, output select circuit 43j, operation circuit 44, and input/output circuit 45. Note that function control circuit 42j is used for function control during a specific period other than laser control. Function control circuit 42j can be formed of a multi-stage shift register, and performs serial-parallel conversion based on signals SL1, SL2, and EN. Signals latched in response to signal EN are directly output outside the laser drive unit like signals LS and SG, and are used in function control of other elements (110, 200). In addition, in the example of FIG. 25, input/output circuit 45 (which can be formed of, e.g., tristate buffers 451 to 453) is arranged in the laser drive unit to be able to perform complicated function control. According to the arrangement shown in FIG. 25, the number of control signals in flexible cable 5 can be reduced. That is, since light-receiving element 110 and front monitor element 200 are also controlled via signal lines that transfers signals SL1, SL2, and EN in addition to laser drive control, the number of control signal lines for elements 110 and 200 can be reduced. In this way, the number of electrical connections of cable 5 can be reduced, thus contributing to improvements of the device reliability and productivity.

### Summary of Embodiments

### Key Points of Embodiments of FIG. 1, etc.

In the optical disc apparatus, since the number of signal lines of flexible cable 5 between pickup 3 and control circuit (board 100) is reduced, the mechanical characteristics such as seek performance of pickup 3 and the like can be improved, thus improving the device reliability.

Flexible cable 5 between pickup 3 and control circuit 100 transfers a timing signal that controls the laser output timing, and mask signals used to mask or blind that timing signal. In the laser control unit that generates a laser drive signal by an arithmetic process of these signals, serial data transfer (that transfers two or more different signals on a single signal line while shifting their timings) is made using signals to attain switching of lasers, switching of laser driver current gains, and the like. In this way, the number of pickup control signal lines is reduced.

### Key Points of Embodiments of FIGS. 22 and 23

Since the sample/hold operation of light-receiving element output signal Vpd in the recording operation is made on pickup 3h, the sample/hold precision is improved, thus consequently improving the recording quality of recording media.

In an optical disc apparatus which can execute a highly reliable recording operation (using a trimming scheme) even when a control signal that passes through flexible cable 5 and the like suffers a signal delay, sample/hold pulse SH is generated from a first laser control timing signal (SL1) on pickup 3h, and light-receiving element output signal Vpd is sampled/held based on pulse SH, thus improving the sample/hold precision.

### Key Points of Embodiment of FIG. 24

The number of signal lines that go through flexible cable 5 tends to increase since the number of functions of pickup head 3 increases. As a result, problems of an increase in weight of flexible cable 5, the adverse influence on seek performance of pickup 3, and the like are pointed out. Since the embodiment shown in FIG. 24 reduced the number of signal lines that go through flexible cable 5 using the trimming pulse scheme, the mechanical load on pickup head 3 due to cable 5 is reduced, and the number of electrical connections is also reduced, thus improving device performance, reliability, and quality.

With increasing recording density of media (optical disc 6), laser drive current control circuit 2 is more complicated and a larger number of wiring lines (signal lines) for timing pulses and masking pulses, which are used to determine the timing of a drive current, are required. In this case, if a time difference is produced in pulse transfer due to different wiring lengths of a plurality of wiring lines, it adversely influences the recording quality. As means for solving this problem, the trimming pulse scheme is known. When the trimming pulse scheme is used, masking signals other than a reference timing pulse can be serially transferred (since a plurality of masking signals need not always be simultaneously transferred).

As an optical disc drive has a higher multiple speed, the differential transfer scheme robust against noise is used in signal transfer that goes through a flexible cable to a pickup head. However, this scheme also has a demerit: the number of signal lines increases since a pair of lines (two lines) are required per signal. The trimming pulse scheme is robust against noise even when no differential scheme is used, and can reduce the number of signal lines of the flexible cable. Especially, since high multiple speed recording of a DVD system or the like uses many masking signals to control complicated laser drive power, this scheme is effective.

### Key Points of Embodiment of FIG. 25

Since other elements (110, 200) on pickup 3 are controlled using a control signal of the laser drive unit, the number of control signals from external circuits of the pickup is reduced. In the laser drive unit that can support multi-functional pickup 3 without increasing the number of control signals, a control signal for laser drive is used to control other elements (light-receiving element 110, front monitor 200) on pickup 3, thereby reducing the number of control signals of flexible cable 5.

As described above, upon practicing one or more of various embodiments of the present invention, control information to pickup 3 which must perform a seek operation to optical disc 6 is serially transferred, thereby reducing the number of signal lines of flexible cable 5. In this way, the flexibility (mobility) of cable 5 can be improved, and flexible cable 5 hardly becomes a mechanical disturbance against the movement of the pickup.

Note that the present invention is not limited to the aforementioned embodiments, and various modifications may be made without departing from the scope of the invention when it is practiced.

The respective embodiments may be combined as needed to form various inventions. For example, some required constituent elements may be omitted from all the required constituent elements disclosed in the embodiments. Furthermore, the required constituent elements according to different embodiments may be combined.

1. An optical disc apparatus comprising:
a disc motor configured to rotate an optical disc;
a pickup having a laser element driven by a drive current, and being configured to irradiate the optical disc with a laser beam;
one or more flexible signal lines configured to transfer control information of the drive current to the pickup; and
a drive control circuit configured to serially transfer the control information to the pickup using at least one of the one or more signal lines.

2. An optical disc apparatus comprising:
a disc motor configured to rotate an optical disc;
a pickup having a laser element driven by a drive current, and being configured to irradiate the optical disc with a laser beam;
a plurality of flexible signal lines configured to transfer, to the pickup, a timing signal used to control laser output timing and a masking signal used to mask or blind the timing signal as at least some components of control information of the drive current; and
a drive control circuit configured to serially transfer the masking signal to the pickup using at least one of the plurality of signal lines.

3. An apparatus according to claim 2, wherein the signal line used to transfer the timing signal is formed of a pair of differential signal transfer lines, the signal line used to transfer the masking signal is formed of one non-differential signal transfer line, and the flexible signal lines include the non-differential signal transfer lines, the number of which is larger than the pair of differential signal transfer lines.

4. An apparatus according to claim 2, wherein the flexible signal lines are configured to transfer, to the pickup, a current switching signal used to switch a current supplied to the laser element as at least a component of control information of the drive current.

5. An apparatus according to claim 4, further comprising a plurality of laser elements, wherein the control information of the drive current includes select information corresponding to a laser select signal used to select one of the plurality of laser elements to which the drive current is to be supplied, and the select information is serially transferred via at least one of the plurality of signal lines.

6. An apparatus according to claim 1, wherein said pickup has the laser element and a different element, and said pickup is configured to irradiate the optical disc with the laser beam and to detect laser reflected light from the optical disc and
a plurality of the flexible signal lines are configured to transfer, to the pickup, a signal or signals used to control an operation of the different element as a component of the control information of the drive current.

7. An apparatus according to claim 2, wherein said pickup has the laser element and a different element, and said pickup is configured to irradiate the optical disc with the laser beam and to detect laser reflected light from the optical disc, and
a plurality of the flexible signal lines are configured to transfer, to the pickup, a signal or signals used to control an operation of the different element as a component of the control information of the drive current.

8. An apparatus according to claim 6, wherein the different element includes a light-receiving element of the laser beam, the control information of the drive current includes function control information corresponding to a signal that makes function control of the light-receiving element, and the function control information is serially transferred via at least one of the plurality of signal lines.

9. An apparatus according to claim 1, wherein said pickup has the laser element and a laser light-receiving element, and said pickup is configured to irradiate the optical disc with the laser beam and to detect laser reflected light from the optical disc, and
a plurality of flexible signal lines are configured to transfer, to the pickup, a signal or signals used to sample/hold a detection signal of the laser light-receiving element as a component of the control information of the drive current.

10. An apparatus according to claim 2, wherein said pickup has the laser element and a laser light-receiving element, and said pickup is configured to irradiate the optical disc with the laser beam and to detect laser reflected light from the optical disc, and
a plurality of flexible signal lines are configured to transfer, to the pickup, a signal or signals used to sample/hold a detection signal of the laser light-receiving element as a component of the control information of the drive current.

11. An apparatus according to claim 9, wherein the pickup includes a sample/hold pulse generation circuit configured to generate a sample/hold pulse by delaying some of signals used in the sample/hold operation, and the light-receiving element includes a sample/hold circuit configured to sample/hold the detection signal of the laser light-receiving element in response to the sample/hold pulse.

12. A method of handling an optical disc, comprising:
rotating the optical disc;
irradiating a laser beam to the optical disc; and
serially transferring control information of the laser beam via a flexible signal line.

13. A method according to claim 12, wherein said control information to be serially transferred includes signals of a timing signal used to control laser output timing and a masking signal used to mask or blind the timing signal.

14. A method according to claim 13, wherein the transferred signals include a pair of differential signals for the timing signal.

15. A method according to claim 14, wherein the transferred signals include a non-differential signal for the masking signal.
